(19) United States
(12) Patent Application Publication
(10) Pub. No.: US 2019/0162552 A1
(43) Pub. Date: May 30, 2019

(54) METHOD FOR PROVIDING A MAP IN A VEHICLE

(71) Applicant: Continental Teves AG & Co. oHG, Frankfurt am Main (DE)

(72) Inventors: Ulrich Stählin, Rochester, MI (US); Attila Jaeger, Darmstadt (DE); Marc Menzel, Weimar (Lahn) (DE); Richard Scherping, Liederbach am Taunus (DE)

(21) Appl. No.: 16/321,188

(22) PCT Filed: Mar. 9, 2017
(86) PCT No.: PCT/DE2017/200021

§ 371 Date: Jan. 28, 2019

(30) Foreign Application Priority Data
Aug. 2, 2016 (DE) 10 2016 214 257.7

(51) Int. Cl. G01C 21/36; G06F 16/29; G06F 16/23

(52) U.S. Cl. CPC G01C 21/3676; G06F 16/23; G06F 16/29

(57) ABSTRACT

A method for providing a map in a vehicle, wherein an initial map is stored, route information is obtained and the map is provided based on the initial map and the route information.

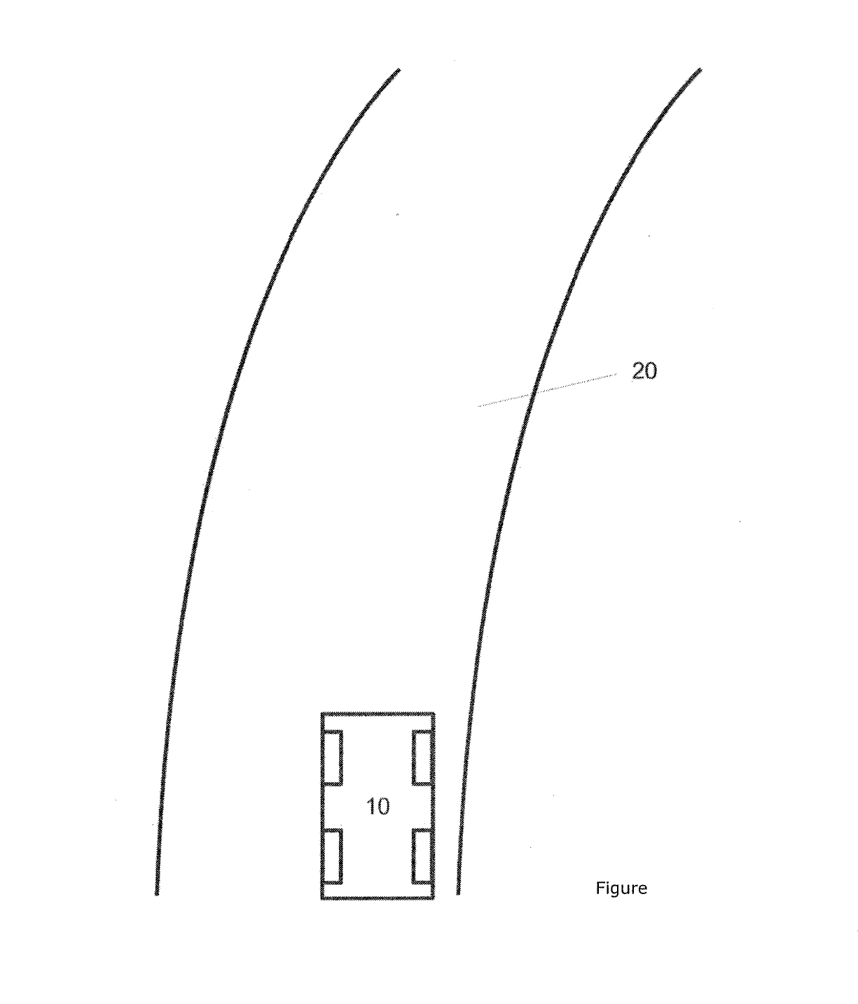

### CROSS REFERENCE TO RELATED APPLICATIONS

This application is the U.S. National Phase Application of PCT International Application No. PCT/DE2017/200021, filed Mar. 9, 2017, which claims priority to German Patent Application No. 10 2016 214 257.7, filed Aug. 2, 2016, the contents of such applications being incorporated by reference herein.

### FIELD OF THE INVENTION

The invention relates to a method for providing a map in a vehicle. Maps in the form of digital maps are used in vehicles for a plurality of functions. For example, they are deployed for navigation purposes or for autonomous driving.

### BACKGROUND OF THE INVENTION

In principle, it is possible to use a completed commercial map. However, such maps are very expensive. In addition, they typically have to be regularly updated, which is associated with a corresponding outlay and likewise high costs. It is, however, advantageous that suitable map data are always available and can be provided to an application if necessary.

### SUMMARY OF THE INVENTION

An aspect of the invention is a method for providing a map, which is executed as an alternative to this.

An aspect of the invention relates to a method for providing a map in a vehicle, which has the following steps:
storing an initial map,
receiving route information, and
providing the map based on the initial map and the route information.

Due to the method according to an aspect of the invention it is possible to have recourse, in the case of the initial map, to a map which is less precise than a common commercial map. Consequently, it is in particular possible to have recourse to significantly less expensive maps for such an initial map, meaning the costs can be significantly reduced. Nevertheless, due to the route information obtained, a high degree of accuracy can be achieved on providing a map, since the inaccuracy of the initial map, compared with a common precise commercial map, can at least be partially compensated for by means of the route information.

It should be understood here that the provision particularly involves a process in which a map or a section of a map is to be supplied to an application implemented in the vehicle or to a control module available in the vehicle or another unit, so that navigation tasks, control tasks or other tasks can, for example, be executed. Thus, the provision does not typically include the mere stockpiling of data which indicate the course of roads. The term ‘providing a map’ is to be understood generically here, so that different data can be provided as the map, as described in greater detail further below.

It should be understood that the term ‘providing a map’ can also, in particular, denote providing a region or map section or a section of a map, wherein a requesting application can, for example, specify a section or region of the map.

The initial map is preferably stored during the manufacture of the vehicle. A first initialization can therefore be effected. However, a new initial map can also be stored or this can be updated, for example if new map material becomes available.

The initial map can, in particular, be stored in a storage device of the vehicle, which is provided for this purpose.

According to one embodiment of the invention, the route information can be based on position data of the vehicle or can be or include position data of the vehicle. Such position data can, for example, be obtained from satellite navigation or other navigation such as, for example, by means of mobile networks or cameras. For example, routes can therefore be matched and accordingly adjusted.

The route information can alternatively or additionally also be based on position data of other vehicles or can be or include position data of other vehicles. Such position data of other vehicles can in particular be received by means of vehicle-to-X communication. However, other types of communication, for example via an ordinary mobile network, are also possible. Position data of other vehicles can be used in an identical or similar manner to the vehicle's own position data.

Therefore, the basis of possible position data is in particular significantly extended. Recourse can essentially be had to all of the position data which are obtained from other vehicles, for example within the framework of the vehicle-to-X communication which is performed locally in each case.

According to one embodiment, it is provided that until such time as route information has been obtained, the map is only based on the initial map or only includes the initial map. Therefore, it can in particular be achieved that the initial map is used if no other information is yet available. It is true that the initial map may be inaccurate, however this is still better than not having any map available.

According to one embodiment, it is provided that, after route information has been obtained, the map is based on the initial map and the route information. In this case, the route information can thus be used, which can in particular be deployed to improve the typically relatively inaccurate initial map. Possible embodiments are explained below.

According to one embodiment, it is provided that, after route information has been obtained, the map includes the initial map or an unaltered region thereof. This can in particular mean that the initial map is made available to an application or another unit in a vehicle requesting a map, although route information is already available and, consequently, further information can also be made available. Parallel to this, the initial map can be provided again, in particular in order to make it possible for the application to decide itself, on the basis of which map or of which information calculations are to be performed.

According to one embodiment, it is provided that, after route information has been obtained, the map includes the route information or a map compiled based on the route information or a region thereof.

By providing route information, an application or another requesting unit in a vehicle can utilize the route information itself or decide whether and in which way it wishes to utilize the initial map or the route information. By means of a map which is compiled based on the route information, the vehicle can therefore begin, based on the route information which can in particular include position data of the ego vehicle and/or position data of other vehicles as described above, to build up its own map which can, in particular, be more accurate than the initial map. In addition, regions of the map which is itself compiled based on the route information can, in some circumstances, be covered, which are not covered by the initial map.

According to one embodiment, it is provided that, after route information has been obtained, the initial map is updated based on the route information, so that an updated map is produced. The updated map is consequently the updated version of the initial map. In this case, courses of roads or other routes can, for example, be adjusted or updated or even refined. The updated map can be saved instead of the initial map or it can also be saved in addition to the initial map.

According to one preferred embodiment, the updated map is subdivided into regions, to each of which a measure of confidence is assigned, which is increased during each update. As a result, the measure of confidence can be enlisted in order to estimate how reliable a respective region in the updated map is. If it has already been updated multiple times, for example because the vehicle has already frequently driven the relevant route, or has obtained relevant data from other vehicles which have driven the route, a high measure of confidence can indicate that the map in this region is very reliable.

According to one embodiment, the map includes the updated map if and inasmuch as an updated map is available. In this case, the map can, for example, only include the updated map or it can include the updated map in addition to other components such as, for example, of the initial map. In the latter case, a requesting unit or an application can itself decide which component of the map, that is to say for example the initial map or the updated map, it wishes to use. A relevant measure of confidence can, in this case, also be transmitted as well for example.

According to one embodiment, the initial map is marked as unconfirmed or has a low measure of confidence. This can be used in order to indicate that the initial map is a less reliable map which has not itself been checked yet. Applications can react accordingly to it. According to one embodiment, it is provided that if an updated map has already been compiled for a region, the map does not include this region of the initial map. As a result, the provision of the initial map can be dispensed with, if information which has already been updated is available for a specific region.

The initial map can be a freely available map according to one advantageous embodiment. This can, in particular, be an OpenStreetMap (OSM) map.

OpenStreetMap (OSM) is a project which compiles digital map data by means of volunteer helpers and makes it available online.

A so-called road graph represents the prior art and has already been repeatedly used in research projects and field tests for vehicle-to-X communication. In addition, self-learning maps at least constitute the state of research.

A road graph or a self-learning map can in principle be compiled in two ways, which can also be combined:
Use of the ego driving trajectory,
Use of information from received vehicle-to-X messages.

In this case, a road graph typically describes a method, in which a map of the surroundings is temporarily compiled from the received vehicle-to-X messages. On the other hand, the term ‘self-learning map’ typically denotes a method which compiles a permanently stored map on the basis of the vehicle's own movement and possibly extends this by data from other vehicles. These procedures can also be accordingly applied in the case of a method according to an aspect of the invention.

However, the disadvantage of these two methods, in isolation, is that they only function if the vehicle either drives the route itself or drives the route itself often enough, or there are plenty of other vehicles in the surroundings. Roads, which the vehicle has not used itself or on which no other vehicles are located, do not therefore appear in the map.

For example, data from an initial map, in particular an OpenStreetMap map, can be used as the basis of a road graph and/or a self-learning map. An OpenStreetMap map is available free of charge, even if it does not have the same guaranteed quality as map data which can be purchased. Most notably, regional coverage cannot be guaranteed. In addition, significantly fewer attributes are included in available OSM data than in commercial digital map data. However, the 2D topology which is relevant for vehicle-to-X communication and some other applications is typically available.

Even if the OSM data is wrong or no data at all is available, this situation is still better than a starting point entirely without data. However, in order to signal that the OSM data are of unknown quality, these can accordingly be provided with a very low reliability value or even with a special flag which indicates that they are unconfirmed. Applications which use the road graph or the self-learning map can thus identify that the relevant data do not have a guarantee of quality, and can deal with the data accordingly.

If a previously unconfirmed region is reached for the first time or if data are received for the first time for such a region, there are several methods for dealing with this scenario:
The new data immediately replace the OSM data.
The road graph or the self-learning map is compiled on the basis of the new data, parallel to the OSM data, and also improved later. With this approach, it is a good idea to make both forms of map information available to the functions. The evaluation is therefore transmitted to the application.
The OSM data are used as a road graph or self-learnt maps from the past, i.e. the entirely normal optimization method of the relevant implementation, which would be performed even without OSM data, is performed with the new information.

In order to keep the size of the OSM data as small as possible, it is a good idea not to use the complete OSM database, but explicitly only the data or attributes which a road graph or a self-learnt map would make available. For example, these can also be prominent points only.

The availability of a road graph or a self-learning map is significantly increased by the embodiment described herein which has initialization with an initial map or with OSM data, without immediately generating the costs of quality-assured map data.

### BRIEF DESCRIPTION OF THE DRAWINGS

The person skilled in the art will infer further features and advantages from the embodiment example described below with respect to the appended drawing, wherein:

The Figure shows an arrangement for performing a method according to an aspect of the invention.

### DETAILED DESCRIPTION OF THE PREFERRED EMBODIMENTS

The Figure shows a vehicle 10 which is driving on a road 20. Both the vehicle 10 and the road 20 are merely represented schematically in this case. A map, which has been initialized by an OpenStreetMap map, is located in the vehicle 10. These data are freely available data which can be used in a vehicle as original equipment.

If the vehicle 10 is driving along the road 20, it can establish its position by means of locating means which are not further represented, in particular a satellite navigation unit, and can consequently identify the exact course of the road 20.

An updated map is then compiled by means of such information, said updated map being stored in addition to the initial map, which is based on OSM data, in the vehicle 10.

If an application, for example a vehicle-to-X application, then requests a map for a specific region, this application receives both the initial map and the updated map. Each time the vehicle 10 drives along the road 20, a measure of confidence of the updated map is increased and this measure of confidence is also transferred to the relevant application. The application can then decide itself whether it trusts the initial map or the updated map.

In this way, it is advantageously possible to dispense with the provision of expensive commercial maps.

It should be pointed out in general that vehicle-to-X communication means, in particular, a direct communication between vehicles and/or between vehicles and infrastructure devices. For example, therefore, vehicle-to-vehicle communication or vehicle-to-infrastructure communication may be involved. Where communication between vehicles is referred to within the framework of this application, this can essentially, for example, take place within the framework of vehicle-to-vehicle communication, which typically takes place without the intermediary of a mobile network or a similar external infrastructure and which can therefore be distinguished from other solutions which, for example, are based on a mobile network. For example, vehicle-to-X communication can take place using the standards IEEE 802.11p or IEEE 1609.4. Vehicle-to-X communication can also be referred to as C2X communication. The sub-areas can be referred to as C2C (Car-to-Car) or C2I (Car-to-Infrastructure). An aspect of the invention expressly does not, however, exclude vehicle-to-X communication with the intermediary of, for example, a mobile network.

The indicated steps of the method according to an aspect of the invention can be executed in the indicated order. They can, however, also be executed in another order. The method according to an aspect of the invention can be executed in one of its embodiments, for example with a specific combination of steps, such that no further steps are executed. However, further steps can essentially also be executed, including those which are not indicated.

The claims which form part of the application do not constitute a waiver of the attainment of more extensive protection.

If in the course of the proceedings it transpires that a feature or a group of features is not absolutely necessary, then the applicant here and now seeks a wording of at least one independent claim, no longer having the feature or the group of features. This may, for example, involve a sub-combination of a claim existing as at the application date or a sub-combination of a claim existing as at the application date restricted by further features. Such claims or combinations of features, which are to be newly worded, are understood to also be covered by the disclosure of this application.

It is further pointed out that configurations, features and variants of aspects of the invention, which are described in the various embodiments or embodiment examples and/or shown in the figures, can be combined with one another as desired. Individual or multiple features are interchangeable as desired. Resulting combinations of features are understood to also be covered by the disclosure of this application.

Back references in dependent claims should not be construed as a waiver of the right to independent, objective protection for the features of the subclaims referred back to. These features can also be used in any combination with other features.

Features which are only disclosed in the description or features which are disclosed in the description or a claim only in conjunction with other features can, in principle, be of independent inventive relevance. They can therefore also be included separately in claims to distinguish from the prior art.

1. A method for providing a map in a vehicle comprising:
storing an initial map,
receiving route information, and
providing the map based on the initial map and the route information,
wherein the route information is based on position data of the vehicle is or includes position data of the vehicle and/or
wherein the route information is based on position data of other vehicles or is or includes position data of other vehicles, wherein the position data of other vehicles are received by vehicle-to-X communication.

2. The method according to claim 1,
wherein the initial map is stored during the manufacture of the vehicle.

3. The method according to claim 1,
wherein, until such time as route information has been obtained, the map is only based on the initial map or only includes the initial map.

4. The method according to claim 1,
wherein, after route information has been obtained, the map is based on the initial map and the route information.

5. The method according to claim 1,
wherein, after route information has been obtained, the map includes the initial map or an unaltered region thereof.

6. The method according to claim 1,
wherein, after route information has been obtained, the map includes the route information or a map compiled based on the route information, or includes a region thereof.

7. The method according to claim 1,
wherein, after route information has been obtained, the initial map is updated based on the route information, so that an updated map is produced.

8. The method according to claim 7,
wherein the updated map is subdivided into regions, to each of which a measure of confidence is assigned, which is increased during each update.

9. The method according to claim 7,
wherein the map includes the updated map if and inasmuch as an updated map is available.

10. The method according to claim 1,
wherein the initial map is marked as unconfirmed or has a low measure of confidence.

11. The method according to claim 1,
wherein, if an updated map has already been compiled for a region, the map does not include this region of the initial map.

12. The method according to claim 1,
wherein the initial map is a freely available map, in particular an OpenStreetMap (OSM) map.

13. The method according to claim 8, wherein the map includes the updated map if and inasmuch as an updated map is available.
